(19) United States
(12) Patent Application Publication
(10) Pub. No.: US 2008/0254845 A1
(43) Pub. Date: Oct. 16, 2008

(54) ANTENNA MODULE AND APPARATUS UTILIZING THE SAME

(76) Inventors: Jinn-Ja Chang, Taipei County (TW); Zu-June Wang, Kaohsiung City (TW)

Correspondence Address: NORTH AMERICA INTELLECTUAL PROPERTY CORPORATION, P.O. BOX 506, MERRIFIELD, VA, 22116, US

(21) Appl. No.: 11/758,662

(22) Filed: Jun. 5, 2007

(30) Foreign Application Priority Data
Apr. 16, 2007 (TW) 096113316

(51) Int. Cl. H04M 1/00; H01Q 21/00; H04B 1/02

(52) U.S. Cl. 455/575.5; 343/835; 455/101; 455/552.1; 455/562.1

(57) ABSTRACT

An antenna module and a signal-processing module using the antenna module to process a plurality of wireless signals are proposed. The signal-processing module includes the antenna module, a first processing circuit and a second processing circuit. The antenna module includes at least a first antenna, at least a second antenna and a shielding portion. The first antenna is utilized to transmit or receive signals corresponding to a first wireless communication standard, the second antenna is utilized to transmit or receive signals corresponding to a second wireless communication standard, and the shielding portion is disposed between the first antenna and the second antenna. The first processing circuit is coupled to the first antenna for processing signals of the first antenna, and the second processing circuit is coupled to the second antenna for processing signals of the second antenna.

### BACKGROUND OF THE INVENTION

1. Field of the Invention

The present invention relates to a signal-processing module and an antenna module of the signal-processing module, and more particularly, to a signal-processing module able to process a plurality of wireless communication signals, the antenna module thereof and the apparatus using the same.

2. Description of the Prior Art

Worldwide Interoperability for Microwave Access (WiMAX) and Wireless Fidelity (WiFi) are two popular wireless wideband communication techniques. WiMAX is a standard interface according to IEEE 802.16 specification, and is designed for Asynchronous Transfer Mode (ATM), frame relay circuits, Ethernet or other communication protocols. WiMAX-based systems can be used to transmit signals in a broad range (such as tens of miles in a high-power authorization channel), whereas WiFi-based systems conforming to IEEE 802.11 specification is suitable for short-distance wireless accessing between buildings and hot spots in a wireless local area network.

Manufacturers are enthusiastic about integrating WiMAX and WiFi. For example, utilizing WiMAX to connect the broadband networks in buildings located within the coverage of WiMAX base stations, and providing wireless surfing functions inside the buildings utilizing WiFi can reduce district limitation and increase wireless transmission efficiency. In this application, the communication devices (e.g. modems) utilized by the users must be able to communicate signals with the WiMAX base station and transmit/receive WiFi signals in the buildings at the same time. However, WiMAX and WiFi bands are so close (WiMAX is 2.3-2.4 GHz, 2.5-2.7 GHz or 3.5-3.7 GHz, while WiFi is 2.4 GHz) that the conventional method of selecting a receiving bandwidth by properly designing the length of the antenna cannot help the modem to distinguish WiMAX signals from WiFi signals. Additionally, the strength of a WiFi signal is usually much larger than a WiMAX signal received from the base station since the WiFi signal is transmitted over a shorter distance. Therefore, when the modem processes a WiMAX signal and a WiFi signal at the same time, the WiFi signal may interfere with the WiMAX signal, thereby influence the communication quality.

Furthermore, there are other wireless signals, such as Bluetooth signals that use a 2.4 GHz-2.483 GHz band, and 3G signals that use 1885-1980 MHz, 2010-2025 MHz or 2110-2170 MHz bands. Meanwhile, GSM signals use 900 MHz, 1800 MHz and 1900 MHz bands, wherein 890-915 MHz of the 900 MHz band is utilized to upload cell signals to the base station, and 935-960 MHz is utilized to download signals from the base station to the cell phone. The system using this band is generally named GSM900. 1710-1785 MHz in the 1800 MHz band is for uplink, and 1805-1880 MHz is for downlink. The system using this band is generally named Digital Cellular System (DCS) 1800 or GSM1800. A cell phone able to support both GSM900 and DCS 1800 is called a dual-band cell phone. 1850-1910 MHz in the 1900 MHz band specially used in USA/Canada is for uplink, and 1930-1990 MHz is for downlink. A cell phone able to support the above three bands is called a tri-band cell phone. As can be seen from the above data, the bands of these wireless communication signals are very close. That is, if multiple systems are integrated in a same module or a same chip, there will be interference among signals.

### SUMMARY OF THE INVENTION

One of the objectives of the present invention is therefore to provide a signal processing module that can process a plurality of wireless communication signals (such as WiMAX signals and WiFi signals), and an antenna module applied in the signal-processing module to solve the aforementioned problems.

According to an exemplary embodiment of the present invention, an antenna module is disclosed. The antenna module comprises at least a first antenna, at least a second antenna and a shielding portion. The first antenna is utilized to transmit or receive signals corresponding to a first wireless communication standard, the second antenna is utilized to transmit or receive signals corresponding to a second wireless communication standard, and the shielding portion is disposed between the first antenna and the second antenna.

According to another exemplary embodiment of the present invention, a signal-processing module is disclosed. The signal-processing module comprises an antenna module, a first processing circuit and a second processing circuit. The antenna module comprises at least a first antenna, at least a second antenna and a shielding portion. The first antenna is utilized to transmit or receive signals corresponding to a first wireless communication standard, the second antenna is utilized to transmit or receive signals corresponding to a second wireless communication standard, and the shielding portion is disposed between the first antenna and the second antenna. The first processing circuit is coupled to the first antenna for processing signals of the first antenna, and the second processing circuit is coupled to the second antenna for processing signals of the second antenna.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of an antenna module according to an exemplary embodiment of the present invention.

FIG. 2 is a block diagram of a signal-processing module according to an exemplary embodiment of the present invention.

### DETAILED DESCRIPTION

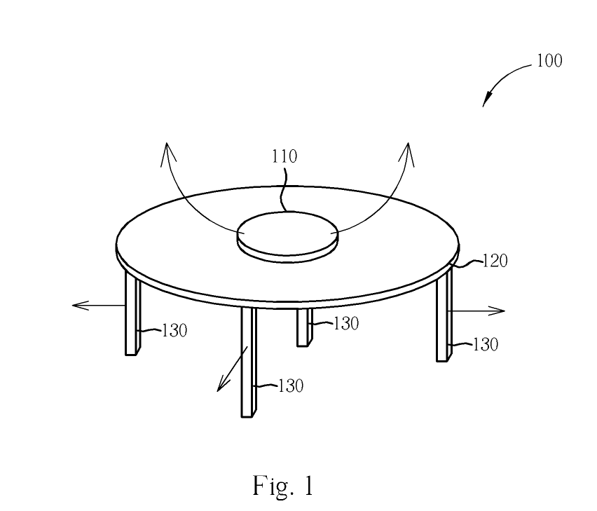

Please refer to FIG. 1, which is a diagram of an antenna module 100 according to an exemplary embodiment of the present invention. In this embodiment, the antenna module 100 comprises at least a first antenna 110, at least a second antenna 130, and a shielding portion 120. The first antenna 110 is utilized to transmit or receive signals corresponding to a first wireless communication standard, such as WiMAX signals. The second antenna 130 is utilized to transmit or receive signals corresponding to a second wireless communication standard, such as WiFi signals. The shielding portion 120 is located between the first antenna 110 and the second antenna 130 for isolating the first antenna 110 and the second antenna 130 in order to reduce or eliminate interference between them. As shown in FIG. 1, the shielding portion 120 is a flat board having two sides, wherein the first antenna 110 is disposed on a first side and the second antenna 130 is disposed on a second side. In order to reduce the signal interference between the first antenna 110 and the second antenna 130, at least part of the shielding portion 120 is made of metal, electromagnetic wave reflection material, electromagnetic wave absorption material, or materials able to achieve the shielding result. The shape of the shielding portion 120 is not necessarily limited to the flat board or the round shape shown in FIG. 1. The shielding portion 120 can have other shapes such as a square, a rectangular or a polygonal form. Please note that the number and the shape of the first antenna 110, the second antenna 130 and the shielding portion 120 in FIG. 1 are only an embodiment of the present invention, that is, the number of first antennas 110 and second antennas 130, and the connection and disposition between the shielding portion 120, the first antenna 110 and the second antenna 130 are not limited to that shown in FIG. 1. Therefore, other designs obeying the aforementioned spirit all fall within the scope of the present invention. For example, the first antenna 110 could comprise a plurality of first antennas etc.

Moreover, in order to further reduce the signal interference between the first antenna 110 and the second antenna 130, the field directivity of the first antenna 110 and the second antenna 130 can be designed to become different by performing antenna polarization. For example, referring to the directions of the arrowheads in FIG. 1, the field of the first antenna 110 distributes in the first side of the shielding portion 120 and points upward (assuming that the first side of the shielding portion 120 faces upward), and the field of the second antenna 130 distributes in the second side and points horizontally (assuming that the second antenna 130 is disposed vertically) in this embodiment. Furthermore, if there are a plurality of second antennas 130 in the antenna module 100, the plurality of second antennas 130 can be equally disposed on the second side of the shielding portion 120. Each second antenna 130 can be designed to have a best receiving direction to receive signals from each direction respectively. Therefore, when one of the second antennas 130 is detected to have the best receiving performance (for example, the antenna is closest to the base station), the signal of that antenna can be selected for further processing. Due to the different transmitting/receiving angles of the first antenna 110 and the second antenna 130 and the shielding effect of the shielding portion 120, the signal interference situation can be reduced to almost negligible. Hence, the antenna module 100 is able to transmit or receive signals of different wireless communication standards.

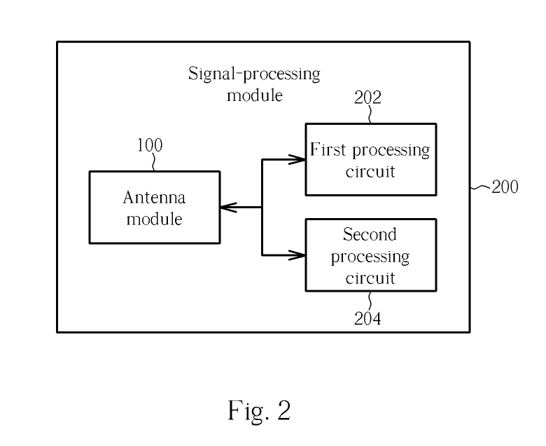

Please refer to FIG. 2 in conjunction with FIG. 1. FIG. 2 is a block diagram of a signal-processing module 200 according to an exemplary embodiment of the present invention. In this embodiment, the signal-processing module 200 comprises the antenna module 100 shown in FIG. 1, a first processing circuit 202 and a second processing circuit 204. When the antenna module 100 is implemented in the signal-processing module 200 (for example, a laptop or a communication chip), the first processing circuit 202 is coupled to the first antenna 110 to process signals of the first antenna 110 (e.g. process data to be output or received via the first antenna 110), and the second processing circuit 204 is coupled to the second antenna 130 to process signals of the second antenna 130 (e.g. process data to be output or received via the second antenna 130). Taking the signal-processing module 200 integrating WiMAX and WiFi as an example, the first antenna 110 can be designed to have an upward transmitting field to transmit WiFi signals in a small area, and the second antenna 130 can be designed to have a horizontal field direction to receive WiMAX signals from the WiMAX base station at a long distance. Since the field of the first antenna 110 distributes in one side of the shielding portion 120, and the shielding portion 120 provides an effective isolation between the first and the second antennas, the interference caused by the WiFi signal to the WiMAX signal at a WiMAX receiving end in the signal-processing module 200 can be decreased to a minimum, therefore enabling the second processing circuit 204 to demodulate the received WiMAX signals correctly. After performing some simulations, it is found that the antenna module 100 can considerably decay WiFi signals received by the WiMAX receiving end. For example, the intensity of WiFi signals received by the WiMAX receiving end is at least less than −25 dB. Similarly, when the first antenna 110 receives WiFi signals, the interference caused by the WiMAX signal to the WiFi signal can be decreased to a minimum as well, enabling the first processing circuit 202 to demodulate the received WiFi signals correctly. Therefore, the antenna module 100 provides a considerable shielding effect between the first antenna 110 and the second antenna 130, making the signal-processing module 200 able to process WiMAX and WiFi signals at the same time while maintaining an excellent communication quality.

As can be seen from the above embodiments, the antenna module 100 and the signal-processing module 200 can successfully solve the interference problem between a short-distance transmission signal (e.g. WiFi signal) and a long-distance transmission signal (e.g. WiMAX signal). Hence, as well as processing different kinds of wireless communication signals simultaneously, the signal-processing module 200 can be applied to integrate long-distance transmission signals (e.g. WiMAX signals, 3G signals or GSM signals) with short-distance transmission signals (e.g. WiFi signals or Bluetooth signals). As the signal-processing module 200 is utilized to transmit/receive a long-distance transmission signal and a short-distance transmission signal, the receiving end of the long-distance transmission signal will not be interfered with by the short-distance transmission signal of stronger intensity, nor will the receiving end of the short-distance transmission signal be interfered with by the long-distance transmission signal, and therefore the communication quality can be maintained.

In addition, the antenna module can be implemented in a laptop, router, wireless base station, wireless network interface card etc. to provide a communication system with the ability to process a plurality of wireless communication signals at the same time while maintaining a good communication quality.

Those skilled in the art will readily observe that numerous modifications and alterations of the device and method may be made while retaining the teachings of the invention.

What is claimed is:

1. An antenna module, comprising:
at least a first antenna, for transmitting or receiving signals corresponding to a first wireless communication standard;
at least a second antenna, for transmitting or receiving signals corresponding to a second wireless communication standard; and
a shielding portion, disposed between the first antenna and the second antenna.

2. The antenna module of claim 1, wherein at least part of the shielding portion is made of metal, electromagnetic wave reflection material or electromagnetic wave absorption material.

3. The antenna module of claim 1, wherein field directions of the first antenna and the second antenna are different.

4. The antenna module of claim 1, wherein the first antenna is disposed on a first side of the shielding portion, and the second antenna is disposed on a second side of the shielding portion.

5. The antenna module of claim 4, wherein a field of the first antenna distributes in the first side, and a field of the second antenna distributes in the second side.

6. The antenna module of claim 1, wherein one of the first and the second antennas is utilized to transmit or receive a short-distance transmission signal.

7. The antenna module of claim 6, wherein the short-distance transmission signal is a wireless fidelity (WiFi) signal or a Bluetooth signal.

8. The antenna module of claim 1, wherein one of the first and the second antennas is utilized to transmit or receive a long-distance transmission signal.

9. The antenna module of claim 8, wherein the long-distance transmission signal is a Worldwide Interoperability for Microwave Access (WiMAX) signal, a 3G signal or a Global System for Mobile Communications (GSM) signal.

10. The antenna module of claim 1, wherein one of the first and the second antennas is utilized to transmit or receive a short-distance transmission signal, and the other of the first and second antennas is utilized to transmit or receive a long-distance transmission signal.

11. The antenna module of claim 10, wherein the short-distance transmission signal is a WiFi signal or a Bluetooth signal, and the long-distance transmission signal is a WiMAX signal, a 3G signal or a GSM signal.

12. A signal-processing module, comprising:
an antenna module, comprising:
at least a first antenna, for transmitting or receiving signals corresponding to a first wireless communication standard;
at least a second antenna, for transmitting or receiving signals corresponding to a second wireless communication standard; and
a shielding portion, disposed between the first antenna and the second antenna;
a first processing circuit, coupled to the first antenna, for processing signals of the first antenna; and
a second processing circuit, coupled to the second antenna, for processing signals of the second antenna.

13. The signal-processing module of claim 12, wherein one of the first and the second antennas is utilized to transmit or receive a short-distance transmission signal.

14. The signal-processing module of claim 13, wherein the short-distance transmission signal is a WiFi signal or a Bluetooth signal.

15. The signal-processing module of claim 12, wherein one of the first and the second antennas is utilized to transmit or receive a long-distance transmission signal.

16. The signal-processing module of claim 15, wherein the long-distance transmission signal is a WiMAX signal, a 3G signal or a GSM signal.

17. The signal-processing module of claim 12, wherein one of the first and the second antennas is utilized to transmit or receive a short-distance transmission signal, and the other of the first and second antennas is utilized to transmit or receive a long-distance transmission signal.

18. The signal-processing module of claim 17, wherein the short-distance transmission signal is a WiFi signal or a Bluetooth signal, and the long-distance transmission signal is a WiMAX signal, a 3G signal or a GSM signal.

19. The signal-processing module of claim 12, wherein at least part of the shielding portion is made from metal, electromagnetic wave reflection material or electromagnetic wave absorption material.

20. The signal-processing module of claim 12, wherein field directions of the first antenna and the second antenna are different.

21. The signal-processing module of claim 12, wherein the first antenna is disposed on a first side of the shielding portion, and the second antenna is disposed on a second side of the shielding portion.

22. The signal-processing module of claim 21, wherein a field of the first antenna distributes in the first side, and a field of the second antenna distributes in the second side.

23. A laptop, comprising the antenna module of claim 1.

24. A wireless base station, comprising the antenna module of claim 1.

25. A router, comprising the antenna module of claim 1.

26. A wireless network interface card, comprising the antenna module of claim 1.
Page 1 3 of 1 6
